(19) United States
(12) Patent Application Publication
(10) Pub. No.: US 2025/0277963 A1
(43) Pub. Date: Sep. 4, 2025

(54) INFRARED OPTICAL SYSTEM AND INFRARED OPTICAL CAMERA

(71) Applicant: SHENZHEN METALENX TECHNOLOGY CO.,LTD, Shenzhen (CN)

(72) Inventors: Ziliang ZHAO, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 19/034,485

(22) Filed: Jan. 22, 2025

(30) Foreign Application Priority Data
Mar. 2, 2024 (CN) 202410237998.0
Mar. 2, 2024 (CN) 202420399788.7

(51) Int. Cl. G02B 13/14; G02B 1/00; G02B 13/18

(52) U.S. Cl. CPC G02B 13/14; G02B 1/00; G02B 13/18

(57) ABSTRACT

An infrared optical system and an infrared optical camera are provided, and the infrared optical system includes a metalens and an aspheric lens in order from an object side to an image side along an optical axis; the object-side surface of the aspheric lens is convex to the image side, and the image-side surface of the aspheric lens is convex to the image side; the metalens satisfies the condition as follows: 0.8<n_{eff}<3.6; wherein n_{eff} is an effective refractive index; the infrared optical system satisfies the condition as follows:

$$0.36 < \frac{{L}_{1}}{L} < 0.51 ;$$

wherein L₁ is a distance between the object-side surface of the metalens and object-side surface of the aspheric lens; L is a total track length of the infrared optical system.

### CROSS-REFERENCE TO RELATED APPLICATION

This application claims the benefit of priority from both Chinese Patent Applications of No. 202410237998.0 and No. 202420399788.7, filed on Mar. 2, 2024. The content of the aforementioned application, including any intervening amendments thereto, is incorporated herein by reference in its entirety.

### TECHNICAL FIELD

The present disclosure relates to a field of lens, in particular to an infrared optical system and an infrared optical camera.

### BACKGROUND

The optical camera is usually composed of an optical system and a structural element. The infrared optical camera is also called an infrared thermal imaging camera, which refers to an imaging camera working at the waveband of 8˜14 μm. The infrared optical camera can compensate for the defects of the imaging camera of visible light, which can replace visible light imaging in foggy, hazy, rainy, snowy, night and other environments and is widely used in security, vehicle, military and other fields.

In the prior art, the infrared camera is composed of multiple lenses. Because the lens itself has a certain thickness and the preset distance between two adjacent lenses, the optical camera will have a larger volume.

### SUMMARY

One purpose of the present application is to provide an infrared optical system and an optical camera, and the problem that the infrared optical system has a larger volume is solved.

In the first aspect, an infrared optical system is provided, and the infrared optical system includes a metalens and an aspheric lens in order from an object side to an image side along an optical axis;
wherein, each of the metalens and the aspheric lens includes an object-side surface facing towards the object side and an image-side surface facing towards the image side;
the object-side surface of the aspheric lens is convex to the image side, and the image-side surface of the aspheric lens is convex to the image side;
the metalens satisfies the condition as follows:

0.8<n_{eff}<3.6;
wherein n_{eff} is an effective refractive index of the metalens;
the infrared optical system satisfies the condition as follows:

$$0.36 < \frac{{L}_{1}}{L} < 0.51 ;$$

wherein L₁ is a distance between the object-side surface of the metalens and object-side surface of the aspheric lens; L is a total track length of the infrared optical system.

In one embodiment, the infrared optical system satisfies the condition as follows:

2.1D≤ΔΦₘ≤10.4D;
wherein ΔΦₘ is a difference between the maximum focal power of the metalens and the minimum focal power of the metalens at a working waveband.

In one embodiment, the infrared optical system satisfies the condition as follows:

$$2.38 < \frac{{f}_{m}}{f} < 3.44 ;$$

wherein fₘ is a focal length of the metalens, and f is an effective focal length of the infrared optical system.

In one embodiment, the infrared optical system satisfies the condition as follows:

$$91.8 D / mm < \frac{{Φ}_{m}}{{T}_{m}} - \frac{{Φ}_{a}}{{T}_{a}} < 266.7 D / mm ;$$

wherein Tₘ is a thickness of the metalens; Tₐ is a central thickness of the aspheric lens along the optical axis; Φₐ is a focal power of the aspheric lens; Φₘ is a focal power of the metalens.

In one embodiment, the infrared optical system satisfies the condition as follows:

$$4.06 p / mm < \frac{{ϕ}_{max}}{{r}_{m}} ;$$

wherein ϕₘₐₓ is a maximum phase of the metalens, and rₘ is a radius of an effective region of the metalens.

In one embodiment, the infrared optical system satisfies the condition as follows:

$$0.32 < \frac{{n}_{eff}}{{n}_{t}} < 0.98 ;$$

wherein n_{eff} is an effective refractive index of the metalens; nₜ is a refractive index of the aspheric lens.

In one embodiment, the infrared optical system satisfies the condition as follows:

$$5. rad / mm < ∇ {Φ}_{max} - ∇ {Φ}_{min} < 31.2 rad / mm ;$$

wherein ∇Φₘₐₓ is a maximum spatial phase gradient of the metalens; ∇Φₘᵢₙ is a minimum spatial phase gradient of the metalens.

In one embodiment, the infrared optical system satisfies the condition as follows:

$$0.93 < \frac{\vert Δ {gd}_{m} \vert}{\vert Δ {gd}_{t} \vert} < 1.35 ;$$

wherein Δgdₘ is a maximum group delay of nanostructures of the metalens; Δgdₜ is a maximum group delay of the aspheric lens.

In one embodiment, the infrared optical system satisfies the condition as follows:

1<n_{eff}<3.5.

In one embodiment, the infrared optical system satisfies the condition as follows:

$$0.04 {mm}^{- 1} < \frac{{MTF}_{ave}}{L} < 0.052 {mm}^{- 1} ;$$

wherein MTFₐᵥₑ is an average of a value of modulation transfer function at a cut-off frequency of full filed of view; L is a total track length of the infrared optical system.

In one embodiment, a central thickness of the aspheric lens is greater than 1.21 mm, and is less than 3.40 mm.

In one embodiment, the total track length of the infrared optical system is greater than or equal to 6.38 mm, and is less than or equal to 8.7 mm.

In one embodiment, a focal length of the metalens is greater than or equal to 7.404 mm, and is less than or equal to 10.77 mm.

In one embodiment, a back focal length of the infrared optical system is greater than or equal to 3.61 mm, and is less than or equal to 4.08 mm.

In one embodiment, an effective focal length of the infrared optical system is greater than or equal to 3.11 mm, and is less than or equal to 3.4 mm.

In the second aspheric, an infrared optical camera is provided, and the infrared optical camera comprises a lens barrel and the infrared optical system;
the infrared optical system is set inside the lens barrel.

In one embodiment, the infrared optical camera includes a main body portion and a bearing portion;
a first installations hole is set inside the lens barrel;
the bearing portion is connected to one side of the main body portion along the optical axis, and a mounting hole is set on one side of the bearing portion far away from the main body portion;
the first installation hole includes a first hole section and second hole section; the first hole section is set on the main body portion; the second hole section is set on the bearing portion;
a diameter of the second hole section is less than a diameter of the first hole section;
the aspheric lens is set inside the bearing portion, and the metalens is set inside the mounting hole, and the metalens is connected to the bearing portion.

In one embodiment, the infrared optical camera further includes a first-pressing ring and a second-pressing ring;
the first-pressing ring is pressed on the aspheric lens, and the first-pressing ring is connected to the main body portion; the second-pressing ring is pressed on the metalens, and the second-pressing ring is connected to the bearing portion.

In one embodiment, the infrared optical camera further includes a main body portion and a bearing portion; a second installation hole is set in the main body portion, and the aspheric lens is connected to the main body portion; the aspheric lens contacts the bearing portion; the metalens is located at one side of the aspheric lens along the axis direction of the second installation hole, and the metalens is connected to the main body portion.

In one embodiment, the infrared optical camera further comprises a buffer element and a third-pressing ring;
the buffer element is set between the metalens and the aspheric lens;
the third-pressing ring is pressed on the metalens, and the third-pressing ring is connected to the main body.

The infrared optical system provided by the present application includes a metalens and an aspheric lens in order from an object side to an image side along an optical axis; each of the metalens and the aspheric lens includes an object-side surface facing towards the object side and an image-side surface facing towards the image side; the object-side surface of the aspheric lens is convex to the image side, and the image-side surface of the aspheric lens is convex to the image side; the metalens satisfies the condition as follows: 0.8<n_{eff}<3.6; wherein n_{eff} is an effective refractive index of the metalens. The infrared optical system of the present application uses a combination of the metalens and the aspheric lens, and on the premise of the satisfying the imaging requirement the volume of the infrared optical system can be reduced significantly. In this way, the processing cost of the infrared optical system can be reduced. The infrared optical system satisfies the condition as follows:

$$0.36 < \frac{{L}_{1}}{L} < 0.51 ;$$

wherein L₁ is a distance between the object-side surface of the metalens and object-side surface of the aspheric lens; L is a total track length of the infrared optical system.

Other features and advantages of the present application will become apparent by the detailed description below, or will be acquired in part by the practice of the present application.

It should be understood that the above general description and detailed details are exemplary only, and do not limit this application.

### BRIEF DESCRIPTION OF DRAWINGS

The above and other targets, features and advantages of the example embodiment thereof by reference to the accompanying drawings.

FIG. 1 shows a schematic diagram of the architectural layout of the infrared optical system in one embodiment of the present application.

FIG. 2 shows a performance output diagram of an infrared optical system in one embodiment of the present application.

FIG. 3 shows an MTF at the field of view of the infrared optical system in one embodiment of this application.

FIG. 4 shows a performance output diagram of an infrared optical system in the first embodiment of the present application.

FIG. 5 shows an MTF at the field of view diagram of the infrared optical system in one embodiment of this application.

FIG. 6 shows a performance output diagram of an infrared optical system in one embodiment of the present application.

FIG. 7 illustrates an MTF at the field of view of the infrared optical system in one embodiment of this application.

FIG. 8 shows a performance output diagram of an infrared optical system in one embodiment of the present application.

FIG. 9 illustrates an MTF at the field of view of the infrared optical system in one embodiment of this application.

FIG. 10 shows a schematic output diagram of the performance of an infrared optical system in one embodiment of the present application.

FIG. 11 shows an MTF at the field of view of the infrared optical system in one embodiment of the present application.

FIG. 12 shows a schematic structure of an infrared optical camera in one embodiment of the present application.

FIG. 13 shows a schematic structure of an infrared optical camera in one embodiment of the present application.

### DETAILED DESCRIPTION OF EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio, and size of the components are enlarged to illustrate clearly.

In addition, the described features, structures, or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, groups, etc. may be adopted. In other cases, aspects of the present application are blurred without a detailed showing or describing the public structure, method, implementation, or operation to avoid over-dominance.

An infrared optical system 100 is provided by the present application, and the prior art closest to the specifications of the present application to be realized in this application is Chinese Patent CN115079378A. The Chinese Patent CN115079378A discloses a thermal infrared optical camera of short focus and low distortion. The total track length (TTL) of the thermal infrared optical camera of short focus and low distortion is 38.75 mm, which is not beneficial to the development of a miniaturization camera.

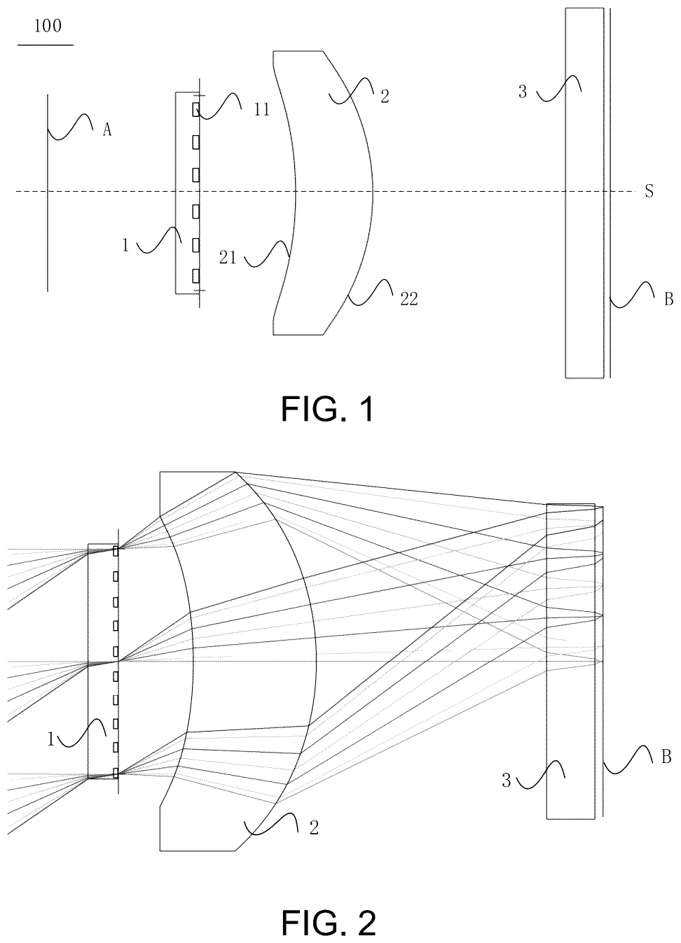

As shown in FIG. 1, FIG. 1 shows a schematic diagram of the architectural layout of the infrared optical system 100 in the first embodiment of the present application. The optical axis S is the center of the beams. In FIG. 1, the left side of the infrared optical system is an object side, and the object plane A is located on the object side; the right side of the infrared optical system is an image side, and the image plane B is located on the image side. Therefore, the direction from the object plane A to the image plane B along the optical axis S is consistent with the direction from the object side to the image side along the optical axis S.

The infrared optical system 100 includes a metalens 1 and an aspheric lens 2 in order from an object side to an image side along the optical axis S.

The metalens 1 is an optical modulation element obtained by setting the structural layer 11 on the substrate, and the plurality of nanostructures arranged in an array to form a structural layer 11. The filler material is filled between the nanostructures, which includes but is not limited to air or other transparent materials at the working waveband of metalens 1. According to the phase modulation method, the parameters of the nanostructures can be configured by a matching phase modulation formula adaptively, so that the metalens 1 can achieve the corresponding optical performance. The number of the structural layer 11 may be one, two or three, and the specific number of the structural layer is not limited.

The structural layer 11 may be set on the substrate that is closer to one side of the aspheric lens 2, or the structural layer 11 may be set on the substrate that is far away from one side of the aspheric lens 2. It should be noted that although the structural layer 11 in FIG. 1 is located on one side that is closer to the aspheric lens 2 of the substrate, it should not be understood that the structural surface 11 can only be provided on the side of the substrate closer to the aspheric lens 2.

The metalens 1 is used to provide the focal power to focus the lights. And the metalens 1 provides different focal lengths at different wavelengths, therefore, the metalens 1 can focus each light of a single wavelength on the image surface in the same position, and the metalens 1 has the function of correcting the chromatic aberrations of the infrared optical system. The metalens satisfies the condition as follows: 0.8<n_{eff}<3.6; wherein n_{eff} is an effective refractive index of the metalens 1. Further, the effective refractive index of the metalens 1 satisfies: 1<n_{eff}<3.5.

The object-side surface of the aspheric lens 2 is convex to the image side, and the image-side surface of the aspheric lens 2 is convex to the image side. The aspheric lens 2 has a first curved surface 21 and a second curved surface 22. Along the optical axis S from the object side to the image side, the first curved surface 21 and the second curved surface 22 are located at two sides of aspheric lens 2, respectively. The first curved surface 21 is closed to the object side, that is, the first curved surface 21 is the object-side surface of the aspheric lens 2. And the object-side surface of the aspheric lens 2 is convex to the image side. The second curved surface 22 is closed to the image side, that is, the second curved surface 22 is the image-side surface 21 of the aspheric lens 2, and the image-side surface of the aspheric lens is convex to the image side. The aspheric lens 2 is used to provide a focal power.

The infrared optical system 100 satisfies the condition as follows:

$$0.36 < \frac{{L}_{1}}{L} < 0.51 ;$$

wherein L₁ is a distance between the object-side surface of the metalens 1 and object-side surface of the aspheric lens 2, and the unit of L₁ is a length measurement; L is a total track length (TTL) of the infrared optical system 100, and the unit of L is a length measurement. As shown in FIG. 1, in the infrared optical system 100, L is a coaxial distance between the center of the image-side surface of the metalens 1 and the image plane. L and L₁ have the same dimension, for example, the unit of L and L₁ is mm.

For the value of

$$\frac{{L}_{1}}{L} ,$$

the length of L₁ will influence the mechanical length of the infrared optical camera including the infrared optical system 100 in the present application. Therefore, the highest value of

$$\frac{{L}_{1}}{L}$$

represents the maximum proportion of the infrared optical system 100 in the infrared optical camera, that is, the lowest value of

$$\frac{{L}_{1}}{L}$$

represents the limit of compressing the length of the optical camera. When the value of

$$\frac{{L}_{1}}{L}$$

is smaller, the mechanical length of the infrared optical camera including the infrared optical system 100 is shorter, so that the volume of the infrared camera including the infrared optical system 100 has been reduced.

In the present application, the metalens 1 is used to provide a focal power and correct the chromatic aberrations at the same time. And the metalens 1 and the aspheric lens 2 are used to correct aberrations. Compared with the two-piece optical system in the related technology, the infrared optical system 100 of the present application uses a combination of metalens 1 and aspheric lens 2, which will reduce the volume and processing cost of the infrared optical system on the premise of satisfying the imaging requirements.

In some embodiments, the metalens 1 satisfies:

$$5. rad / mm < ∇ {Φ}_{max} - ∇ {Φ}_{min} < 31.2 rad / mm$$

wherein ∇Φₘₐₓ, is a maximum spatial phase gradient of the metalens at a central wavelength of the working waveband; ∇Φₘᵢₙ is a minimum spatial phase gradient of the metalens of a central wavelength of the working waveband. Because the spatial phase gradient determines the deflection ability of beams, ∇Φₘₐₓ−∇Φₘᵢₙ represents an ability range of focusing. The highest value of ∇Φₘₐₓ−∇Φₘᵢₙ represents the maximum focusing range, and the lowest value of ∇Φₘₐₓ−∇Φₘᵢₙ represents the minimum focusing range.

In some embodiments, the metalens 1 satisfies:

$$0.93 < \frac{\vert Δ {gd}_{m} \vert}{\vert Δ {gd}_{t} \vert} < 1.35$$

wherein Δgdₘ is a maximum group delay of nanostructures of the metalens 1 at a central wavelength of the working waveband, and the unit of Δgdₘ is time unit; Δgdₜ is a maximum group delay of the aspheric lens 2 at a central wavelength of the working waveband, and the unit of Δgdₜ is a time unit. Δgdₘ and Δgdₜ have the same dimension, for example, the unit of Δgdₘ and Δgdₜ is fm. The dispersion of the metalens 1 matches with the dispersion of the aspheric lens 2, and the metalens 1 and the aspheric lens 2 need to be compensated with each other.

$$\frac{\vert Δ {gd}_{m} \vert}{\vert Δ {gd}_{t} \vert}$$

represents a compensation of the group delay in the infrared optical system 100. The highest value of

$$\frac{\vert Δ {gd}_{m} \vert}{\vert Δ {gd}_{t} \vert}$$

represents the maximum proportion of dispersion of the metalens 1 in the infrared optical system 100. The lowest value of

$$\frac{\vert Δ {gd}_{m} \vert}{\vert Δ {gd}_{t} \vert}$$

represents the minimum proportion of dispersion of the metalens 1 in the infrared optical system 100.

In one embodiment, the infrared optical system 100 satisfies the condition as follows:

$$0.32 < \frac{{n}_{eff}}{{n}_{t}} < 0.98$$

wherein n_{eff} is an effective refractive index of the metalens 1; nₜ is a refractive index of the aspheric lens 2.

$$\frac{{n}_{eff}}{{n}_{t}}$$

represents a ratio of the refractive index of the metalens 1 to the refractive index of the aspheric lens 2 in the infrared optical system 100. The highest value of

$$\frac{{n}_{eff}}{{n}_{t}}$$

represents the maximum ratio of refractive index of the metalens 1 in the infrared optical system 100, and the lowest value of

$$\frac{{n}_{eff}}{{n}_{t}}$$

represents the minimum ratio of refractive index of the metalens 1 in the infrared optical system 100.

In some embodiments, the infrared optical system 100 satisfies the condition with the unit of D as follows:

2.1D≤ΔΦₘ≤10.4D

The metalens 1 is configured to correct the chromatic aberration, therefore the focal power Φₘ of the metalens 1 will change with the changing of the wavelengths of the beams. ΔΦₘ is a difference between the maximum value of the focal power of the metalens 1 (Φₘₐₓ) and the minimum value of the focal power of the metalens 1 (Φₘᵢₙ). And the unit of ΔΦₘ is D (Diopter).

ΔΦₘ represents the ability of the metalens 1 to correct the chromatic aberration. The lowest value of ΔΦₘ represents the minimum ability of the correction of the chromatic aberration for the arrangement and structure of specific lenses in the infrared optical system 100. The highest value of ΔΦₘ represents the maximum ability of the correction of the chromatic aberration for the metalens 1 in the infrared optical system 100. When the metalens 1 has a larger focal power Φₘ, the metalens 1 can provide a better focusing ability for light.

In some embodiments, the infrared optical system 100 satisfies the condition as follows:

$$2.38 < \frac{{f}_{m}}{f} < 3.44$$

wherein fₘ is a focal length of the metalens 1 with a length unit. f is an effective focal length of the infrared optical system 100 with a length unit. fₘ and f have the same measurement, for example, the unit of fₘ and f is mm.

The value of fₘ/f represents the proportion of the focal length of the metalens 1 in the infrared optical system 100, which shows the role of the metalens 1 in focusing. The highest value of fₘ/f represents the minimum ability of focusing of the metalens 1 in the infrared optical system 100. Conversely, the lowest value of fₘ/f represents the maximum ability of focusing of the metalens 1 in the infrared optical system 100.

In some embodiments, the infrared optical system 100 satisfies the condition as follows:

$$0.04 {mm}^{- 1} < \frac{{MTF}_{ave}}{L} < 0.0 \; 52 {mm}^{- 1}$$

MTFₐᵥₑ is an average of a value of modulation transfer function at a cut-off frequency of full field of view. MTF (modulation transfer function) is called spatial contrast transfer function or spatial frequency contrast sensitivity function, which uses a function of spatial frequency that reflects the ability of the optical system to transfer various sinusoidal frequency modulations. L is the total track length of the infrared optical system 100 and is with a unit of mm. The measurement method of L can refer to the above embodiment, and will not be described here.

$$\frac{{MTF}_{ave}}{L}$$

reflects the compressed volume of the infrared optical system 100 and the effect of improving imaging quality. The greater the

$$\frac{{MTF}_{ave}}{L}$$

is, the smaller the volume of the infrared optical system 100, and the better the imaging quality of the infrared optical system 100. The lowest value of

$$\frac{{MTF}_{ave}}{L}$$

represents the basic control ability of imaging quality, when the volume of the infrared optical system 10 is compressed. The highest value of

$$\frac{{MTF}_{ave}}{L}$$

represents the limit control ability of imaging quality, when the volume of the infrared optical system 10 is compressed.

$$\frac{{MTF}_{ave}}{L}$$

is configured to be within [0.043,0.051], which ensures the infrared optical system 100 can output a better imaging quality when the infrared optical system 100 has a smaller volume.

In some embodiments, the infrared optical system 100 satisfies the condition as follows:

$$8 D / mm < \frac{{Φ}_{m}}{{T}_{m}} - \frac{{Φ}_{a}}{{T}_{a}} < 2 66.7 D / mm$$

Wherein, Tₘ is a thickness of the metalens 1, and has a unit of mm; Tₐ is a central thickness of the aspheric lens 2 along the optical axis, and the center of the aspheric surface is an intersection point between the optical axis S and the aspheric surface, and a central thickness of the aspheric lens 2 is a coaxial distance between the two centers of the aspheric surfaces; Φₐ is a focal power of the aspheric lens 2; Φₘ is a focal power of the metalens 1. The unit of Φₐ is D.

$$\frac{{Φ}_{m}}{{T}_{m}} - \frac{{Φ}_{a}}{{T}_{a}}$$

is a difference between the ratio of the focal power of the metalens 1 to the thickness of the metalens 1 and the ratio of the focal power of the aspheric lens 2 to the thickness of the aspheric lens 2, which represents the advantage of the thickness of the metalens 1 when the metalens 1 is providing the focal power compared with the aspheric lens 2. Specifically, the metalens 1 will provide a greater focal power when the metalens 1 has a thinner thickness, so that the volume of the infrared optical system 100 can be significantly reduced.

The lowest value of

$$\frac{{Φ}_{m}}{{T}_{m}} - \frac{{Φ}_{a}}{{T}_{a}}$$

represents the situation where the metalens 1 has a minimum focal power with a unit thickness and the aspheric lens 2 has a maximum focal power with a unit thickness. The highest value of

$$\frac{{Φ}_{m}}{{T}_{m}} - \frac{{Φ}_{a}}{{T}_{a}}$$

represents the situation where the metalens 1 has a maximum focal power with a unit thickness and the aspheric lens 2 has a minimum focal power with a unit thickness.

In some embodiments, the infrared optical system 100 satisfies the condition as follows:

$$4.06 p / mm < \frac{{ϕ}_{max}}{{r}_{m}}$$

ϕₘₐₓ is a maximum phase of the metalens 1, and the unit of ϕₘₐₓ is p, and p represents a rad of 2π. rₘ is a radius of an effective region of the metalens 1, the radius of the effective region of the metalens 1 represents the radius of the effective aperture of the metalens 1, that is, effective region of the metalens 1 is the radius of the region of metalens 1 that the incident beams passes through. It should be noted that when the metalens 1 is a double-sided metalens 1 and the values of ϕₘₐₓ for two structural surfaces 11 are the same, any structural surface 11 is selected randomly for calculation. When the two values of ϕₘₐₓ for two structural surfaces 11 are different, the greater value of ϕₘₐₓ for two structural surfaces 11 is selected for calculation.

The lowest value of

$$\frac{{ϕ}_{max}}{{r}_{m}}$$

represents the minimum value of the maximum phase (ϕₘₐₓ) with the unit radius to be provided by the metalens 1 in the infrared optical system 100 to achieve the target optical performance 100, that is, when the infrared optical system 100 realizes optical performance and compresses the volume at the same time, the maximum phase with a unit radius is greater than 4.06p/mm. The highest value of

$$\frac{{ϕ}_{max}}{{r}_{m}}$$

represents the maximum phase (ϕₘₐₓ) with a unit radius provided by the metalens 1 in the infrared optical system 100.

As shown in FIG. 1, in some embodiments, the infrared optical system 100 further includes an optical protective element 3, and the optical protective element 3 is transparent. The optical protective element 3 is located at the image side of the aspheric lens 2 along the optical axis S. That is, the infrared optical system 100 along the optical axis S includes the metalens 1, the aspheric lens 2, and the optical protective element 3 in order from the object side to the image side.

The optical protective element 3 may be a window glass, but the material of the optical protective element 3 is not limited to silicon. In one embodiment, the optical protective element 3 may be made of germanium (Ge).

This application provides five embodiments of the infrared optical systems 100 satisfying the requirements, next, the infrared optical system 100 provided by the various embodiments of this application is described in detail.

### Embodiment 1

FIG. 2 shows an optical architecture diagram of the infrared optical system 100 provided by one embodiment of the present application. Meanwhile, FIG. 2 also shows the performance of the output of the infrared optical system 100 in embodiment 1 of the present application. As shown in FIG. 2, and combined with FIG. 1, in embodiment 1, the infrared optical system 100 includes a metalens 1, an aspheric lens 2, and an optical protective element 3 along the optical axis S in order from an object side to an image side.

TABLE 1
Target requirements for various system parameters
of the infrared optical system

| System parameters | Data | |
|---|---|---|
| TTL (total track length) | 6.38 | mm |
| Field of view (2ω) | 69.1° | |
| F number | 1.1 | |
| Effective focal length | 3.11 | mm |
| Working waveband | 8~12 | μm |

It can be seen in Table 1 that the infrared optical system 100 works at a working waveband of 8˜12 μm, which can satisfy the requirement of working at a far-infrared waveband. The F number (aperture size) of the infrared optical system 100 is 1.1, which can improve the light intake of the infrared optical system 100 significantly. And when the imaging sensor has a lower response to light, the infrared optical system 100 can collect the optical energy into the infrared optical system 100, which will ensure good imaging quality. At the same time, the infrared optical system 100 has a larger FOV (field of view), and the FOV is 69.1°. At the same time, the total track length of the infrared optical system 100 is only 6.38 mm, which can fully satisfy the requirements of miniaturization and light, therefore it is beneficial to control the volume.

From an object side to an image side, each surface of the infrared optical system 100 provided by the infrared optical system 100 is numbered. After summarizing the parameters of each surface, Table 2 is shown below.

TABLE 2
Parameters of the various surfaces in the infrared
optical system 100 provided by Embodiment 1

| Numbered | | Curvature | | |
|---|---|---|---|---|
| surface | Type of surface | radius | Thickness | Material |
| 1 | Object plane | Infinite | — | — |
| 2 | Spherical surface | Infinite | 0.38 mm | Silicon |
| 3 | Structural surface | Infinite | 0.93 mm | — |
| 4 | Aspheric surface | −5.06 mm | 1.53 mm | IRG206 |
| 5 | Aspheric surface | −3.45 mm | 2.85 mm | — |
| 6 | Spherical surface | Infinite | 0.60 mm | Silicon |
| 7 | Spherical surface | Infinite | 0.10 mm | — |
| 8 | Image plane | Infinite | — | — |

In Table 2, the surface 1 is an object plane. The surface 2 is an object-side surface of the metalens 1. The surface 3 is an image-side surface of a metalens 1, and the nanostructures are set on the surface 3 in the present application, that is, the surface 3 is recorded as a structural surface (metalens). The surface 4 is the object-side surface of the aspheric lens 2. The surface 5 is an image-side surface of the aspheric surface 2. The surface 6 is an object-side surface of the optical protective element 3. The surface 7 is an image-side surface of the optical protective element 3. The surface 8 is an image plane.

It can be seen in Table 2, the curvature radius of surface 1 is infinite. That is, the surface 1 is a plane, and the distance between the surface 1 and the surface 2 is uncertain. There is air filled between surface 1 and surface 2. Surface 2 is a spherical surface, and the distance between the surface 2 and the surface 3 is 0.38 mm. The material between surface 2 and surface 3 is silicon. The surface 3 is a structural surface 11, and the surface 3 is a plane. The distance between the surface 3 and surface 4 is 0.93 mm. There is air filled between surface 3 and surface 4. The curvature radius of surface 4 is −5.06 mm. The distance between surface 4 and surface 5 is 1.53 mm. The material between surface 4 and surface 5 is IRG206, and IRG206 is the trademark of the sulfur glass lens, and specific parameters of IRG206 can refer to the relevant information. The curvature radius of surface 5 is-3.45 mm, and the distance between surface 5 and surface 6 is 2.85 mm. There is air filled between surface 5 and surface 6. The surface 6 is a spherical surface, and the distance between surface 6 and surface 7 is 0.60 mm. The material between surface 6 and surface 7 is silicon. The surface 7 is aspheric surface, and the distance between surface 7 and surface 8 is 0.10 mm. There is air filled between surface 7 and surface 8. The surface 8 is a plane.

The surface 3 and surface 4 are even-order aspheric surfaces, the even-order aspheric surface satisfies the formula as follows:

$$Z ( r ) = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16}$$

wherein r is the radius of any position of the aspheric surface in a radial direction, Z(r) is a vector height of the aspheric surface; c is a curvature of the aspheric surface, c=1/R; and k is a conic coefficient; A, B, C, D, E, F and G are aspheric coefficients.

TABLE 3
Parameters of each even-order aspheric surface in the infrared optical system provided by Embodiment 1

| Numbered | | | | | | | | |
|---|---|---|---|---|---|---|---|---|
| surface | K | 4-order | 6-order | 8-order | 10-order | 12-order | 14-order | 16-order |
| 3 | 1.78E+00 | −3.70E−03 | −7.96E−04 | 4.17E−04 | −1.14E−03 | 7.09E−04 | −1.70E−04 | 1.54E−05 |
| 4 | −2.27E−01 | −1.59E−03 | 3.80E−04 | −4.01E−04 | 3.64E−05 | 1.93E−05 | −5.15E−06 | 3.68E−07 |

Please refer to Table 3, the four-order aspheric coefficient of surface 3 is −3.70E-03, that is, the value of A is equal to −3.70E-03, and the values of B, C, D, E, F and G of surface 3 can be checked in Table 3 according to the above method, and the values of A, B, C, D, E, F and G of surface 4 can also be obtained in Table 3.

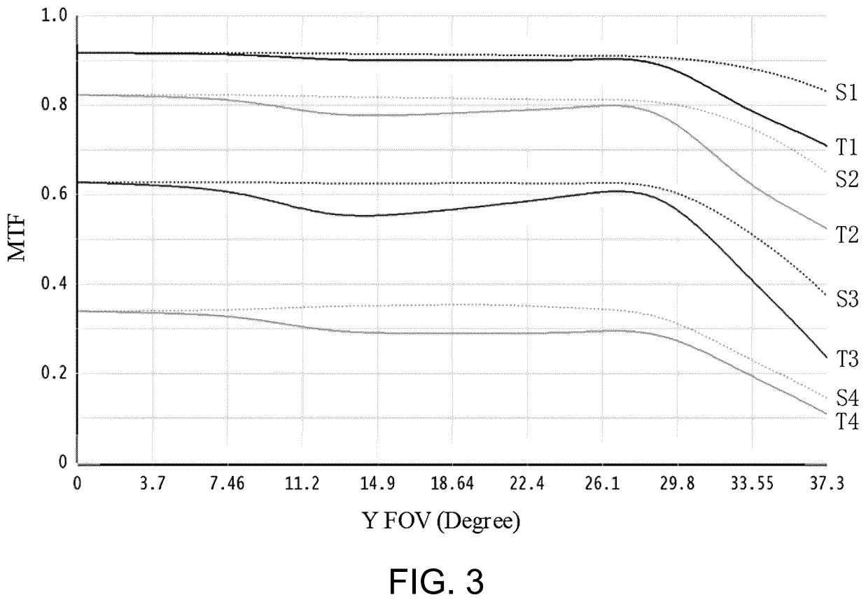

FIG. 3 shows an MTF diagram of the infrared optical system 100 provided by Embodiment 1. The MTF (modulation transfer function) is an important indicator used to describe the imaging quality of an infrared optical system. The larger the value of MTF is, the better the imaging quality. As shown in FIG. 3, the meridional curve T1 and the sagittal curve S1 correspond to the spatial frequency of 5.25 lp/mm (line pair/mm), and the meridional curve T2 and the sagittal curve S2 correspond to the spatial frequency of 10.51 lp/mm, and the meridional curve T3 and the sagittal curve S3 correspond to the spatial frequency of 21 lp/mm, and the meridional curve T4 and the sagittal curve S4 correspond to the spatial frequency of 42 lp/mm. It can be seen in the above eight curves, that although the infrared optical system 100 has poor edge imaging quality, the MTF at the FOV of 33.55° is always greater than 0.2. Therefore, the infrared optical system 100 has better central imaging quality. The Y FOV in FIG. 3 represents the field of view in the direction of the Y axis.

### Embodiment 2

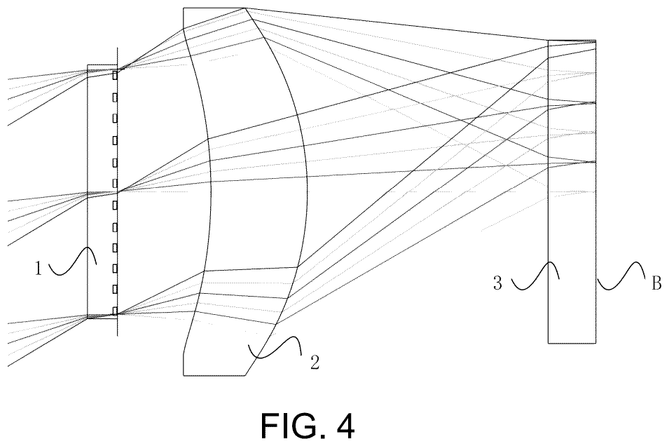

FIG. 4 shows an optical architecture diagram of the infrared optical system 100 provided by embodiment 2 of the present application. At the same time, FIG. 4 shows the outputting optical performance of the infrared optical system 100 in embodiment 2.

As shown in FIG. 4 and FIG. 1, an infrared optical system in the present application, the infrared optical system 100 along the optical axis S includes a metalens 1, an aspheric lens 2, and an optical protective element 3 in order from an object side to an image side.

TABLE 4
Various system parameters of the infrared
optical system provided by Embodiment 2

| System parameters | Data | |
|---|---|---|
| TTL (total track length) | 6.36 | mm |
| Field of view(2ω) | 61.9° | |
| F number | 1.1 | |
| Effective focal length | 3.4 | mm |
| Working waveband | 8~12 | μm |

As shown in Table 4, the infrared optical system 100 provided by the present application works at a target waveband of 8˜12 μm, which can satisfy the requirement of working at a far-infrared waveband. The F number (aperture size) of the infrared optical system 100 is 1.1, which can improve the light intake of the infrared optical system 100 significantly. And when the imaging sensor has a lower response to light, the infrared optical system 100 can collect the optical energy into the infrared optical system 100, which will ensure good imaging quality. At the same time, the infrared optical system 100 has a larger FOV (field of view), and the FOV is 61.9°. At the same time, the total track length of the infrared optical system 100 is only 6.36 mm, which can fully satisfy the requirements of miniaturization and light, therefore it is beneficial to control the volume.

From an object side to an image side, each surface of the infrared optical system provided by the infrared optical system is numbered. After summarizing the parameters of each surface, Table 5 is shown below.

TABLE 5
Parameters of the various surfaces in the infrared
optical system provided by Embodiment 2

| Numbered | | Curvature | | |
|---|---|---|---|---|
| surface | Type of surface | radius | Thickness | Material |
| 1 | Object plane | Infinite | — | — |
| 2 | Spherical surface | Infinite | 0.38 mm | Silicon |
| 3 | Structural surface | Infinite | 1.17 mm | — |
| 4 | Aspheric surface | −5.93 mm | 1.21 mm | IRG206 |
| 5 | Aspheric surface | −3.72 mm | 3.01 mm | — |
| 6 | Spherical surface | Infinite | 0.60 mm | Silicon |
| 7 | Spherical surface | Infinite | 0 mm | — |
| 8 | Image plane | Infinite | — | — |

In Table 5, the surface 1 is an object plane. The surface 2 is an object-side surface of the metalens 1. The surface 3 is an image-side surface of a metalens 1, and the nanostructures are set on the surface 3 in the present application, that is, the surface 3 is recorded as a structural surface (metalens). The surface 4 is the object-side surface of the aspheric lens 2. The surface 5 is an image-side surface of the aspheric surface 2. The surface 6 is an object-side surface of the optical protective element 3. The surface 7 is an image-side surface of the optical protective element 3. The surface 8 is an image plane.

It can be seen in Table 5, the curvature radius of surface 1 is infinite. That is, the surface 1 is a plane, and the distance between the surface 1 and the surface 2 is uncertain. There is air filled between surface 1 and surface 2. Surface 2 is a spherical surface, and the distance between the surface 2 and the surface 3 is 0.38 mm. The material between surface 2 and surface 3 is silicon. The surface 3 is a structural surface 11, and the surface 3 is a plane. The distance between the surface 3 and surface 4 is 1.17 mm. There is air filled between surface 3 and surface 4. The curvature radius of surface 4 is −5.93 mm. The distance between surface 4 and surface 5 is 1.21 mm. The material between surface 4 and surface 5 is IRG206. The curvature radius of surface 5 is −3.72 mm, and the distance between surface 5 and surface 6 is 3.01 mm. There is air filled between surface 5 and surface 6. The surface 6 is a spherical surface, and the distance between surface 6 and surface 7 is 0.60 mm. The material between surface 6 and surface 7 is silicon. The surface 7 is aspheric surface, and the distance between surface 7 and surface 8 is 0 mm. There is air filled between surface 7 and surface 8. The surface 8 is a plane.

The surface 3 and surface 4 are even-order aspheric surfaces, the even-order aspheric surfaces can be determined by the above formula.

TABLE 6
Parameters of each even-order aspheric surface in the infrared optical system provided by Embodiment 2

| Numbered | | | | | | | | |
|---|---|---|---|---|---|---|---|---|
| surface | K | 4-order | 6-order | 8-order | 10-order | 12-order | 14-order | 16-order |
| 3 | 2.20E+00 | 1.67E−03 | −2.66E−03 | 1.66E−03 | −4.64E−04 | 3.60E−05 | 1.23E−05 | −1.82E−06 |
| 4 | −3.03E−01 | −5.68E−04 | 1.69E−04 | −1.88E−04 | 3.00E−05 | 3.82E−06 | −1.73E−06 | 1.95E−07 |

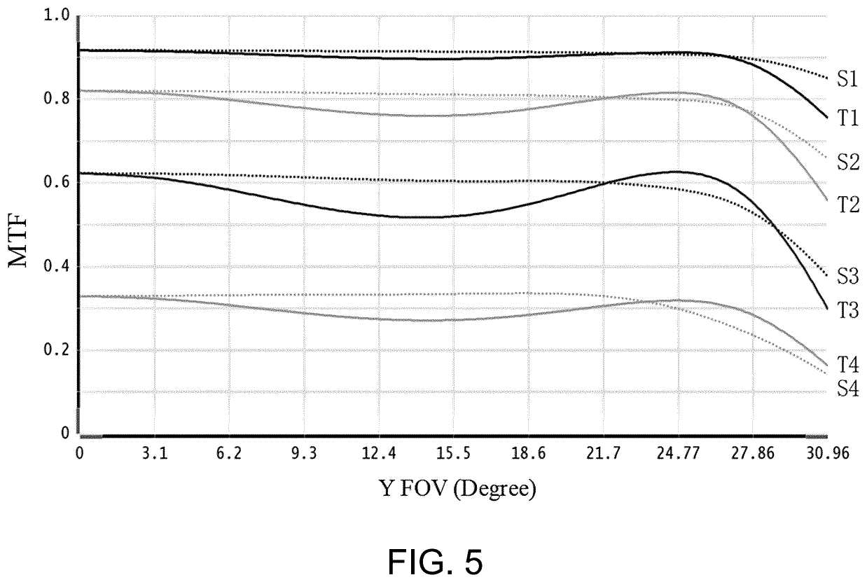

FIG. 5 shows an MTF diagram of the infrared optical system provided by Embodiment 2. The MTF (modulation transfer function) is an important indicator used to describe the imaging quality of an infrared optical system. The larger the value of MTF is, the better the imaging quality. As shown in FIG. 5, the meridional curve T1 and the sagittal curve S1 correspond to the spatial frequency of 5.25 lp/mm (line pair/mm), and the meridional curve T2 and the sagittal curve S2 correspond to the spatial frequency of 10.51 lp/mm, and the meridional curve T3 and the sagittal curve S3 correspond to the spatial frequency of 21 lp/mm, and the meridional curve T4 and the sagittal curve S4 correspond to the spatial frequency of 42 lp/mm. It can be seen in the above eight curves, that although the infrared optical system 100 has poor edge imaging quality, the MTF at the FOV of 28° is always greater than 0.2. Therefore, the infrared optical system 100 has better central imaging quality. The Y FOV in FIG. 5 represents the field of view in the direction of the Y axis.

### Embodiment 3

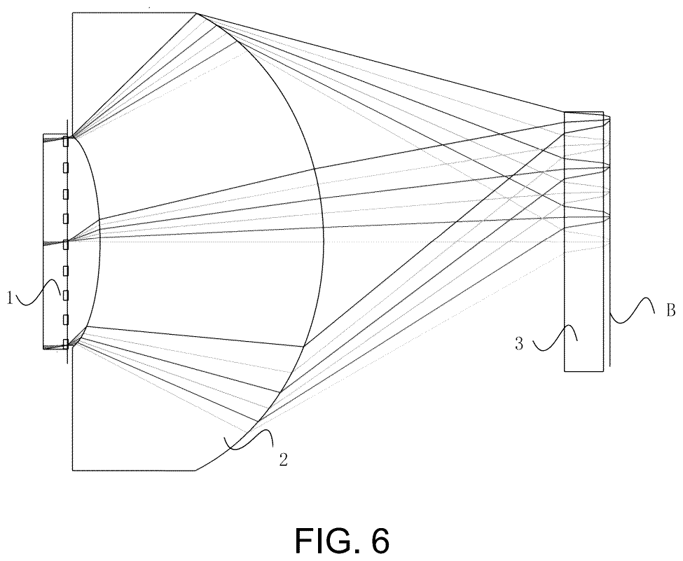

FIG. 6 shows an optical architecture diagram of the infrared optical system 100 provided by embodiment 3 of the present application. At the same time, FIG. 6 shows the outputting optical performance of the infrared optical system 100 in embodiment 3. As shown in FIG. 6 and FIG. 1, an infrared optical system in the present application, the infrared optical system 100 along the optical axis S includes a metalens 1, an aspheric lens 2, and an optical protective element 3 in order from an object side to an image side.

TABLE 7
Various system parameters of the infrared
optical system provided by Embodiment 3

| System parameters | Data | |
|---|---|---|
| TTL (total track length) | 8.7 | mm |
| Field of view (2ω) | 70.1° | |
| F number | 1 | |
| Effective focal length | 3.18 | mm |
| Working waveband | 8~12 | μm |

As shown in Table 7, the infrared optical system 100 provided by the present application works at a target waveband of 8˜12 μm, which can satisfy the requirement of working at a far-infrared waveband. The F number (aperture size) of the infrared optical system 100 is 1, which can improve the light intake of the infrared optical system 100 significantly. And when the imaging sensor has a lower response to light, the infrared optical system 100 can collect the optical energy into the infrared optical system 100, which will ensure good imaging quality. At the same time, the infrared optical system 100 has a larger FOV (field of view), and the FOV is 70.1°. At the same time, the total track length of the infrared optical system 100 is only 8.7 mm, which can fully satisfy the requirements of miniaturization and light, therefore it is beneficial to control the volume.

From an object side to an image side, each surface of the infrared optical system provided by the infrared optical system is numbered. After summarizing the parameters of each surface, Table 8 is shown below.

TABLE 8
Parameters of the various surfaces in the infrared
optical system provided by Embodiment 3

| Numbered | | Curvature | | |
|---|---|---|---|---|
| surface | Type of surface | radius | Thickness | Material |
| 1 | Object plane | Infinite | — | — |
| 2 | Spherical surface | Infinite | 0.38 mm | Silicon |
| 3 | Structural surface | Infinite | 0.5 mm | — |
| 4 | Aspheric surface | −5.40 mm | 3.44 mm | IRG209 |
| 5 | Aspheric surface | −4.55 mm | 3.07 mm | — |
| 6 | Spherical surface | Infinite | 0.60 mm | Silicon |
| 7 | Spherical surface | Infinite | 0.1 mm | — |
| 8 | Image plane | Infinite | — | — |

In Table 8, the surface 1 is an object plane. The surface 2 is an object-side surface of the metalens 1. The surface 3 is an image-side surface of a metalens 1, and the nanostructures are set on the surface 3 in the present application, that is, the surface 3 is recorded as a structural surface (metalens). The surface 4 is the object-side surface of the aspheric lens 2. The surface 5 is an image-side surface of the aspheric surface 2. The surface 6 is an object-side surface of the optical protective element 3. The surface 7 is an image-side surface of the optical protective element 3. The surface 8 is an image plane.

It can be seen in Table 8, the curvature radius of surface 1 is infinite. That is, the surface 1 is a plane, and the distance between the surface 1 and the surface 2 is uncertain. There is air filled between surface 1 and surface 2. Surface 2 is a spherical surface, and the distance between the surface 2 and the surface 3 is 0.38 mm. The material between surface 2 and surface 3 is silicon. The surface 3 is the structural surface 11, and the surface 3 is a plane. The distance between the surface 3 and surface 4 is 0.5 mm. There is air filled between surface 3 and surface 4. The curvature radius of surface 4 is −5.40 mm. The distance between surface 4 and surface 5 is 3.44 mm. The material between surface 4 and surface 5 is IRG209, and IRG209 is the trademark of the sulfur glass lens, and specific parameters of IRG209 can refer to the relevant information. The curvature radius of surface 5 is −4.55 mm, and the distance between surface 5 and surface 6 is 3.07 mm. There is air filled between surface 5 and surface 6. The surface 6 is a spherical surface, and the distance between surface 6 and surface 7 is 0.60 mm. The material between surface 6 and surface 7 is silicon. The surface 7 is aspheric surface, and the distance between surface 7 and surface 8 is 0.1 mm. There is air filled between surface 7 and surface 8. The surface 8 is a plane.

The surface 3 and surface 4 are even-order aspheric surfaces, the even-order aspheric surfaces can be determined by the above formula.

TABLE 9
Parameters of each even-order aspheric surface in the infrared optical system provided by Embodiment 3

| Numbered | | | | | | | | |
|---|---|---|---|---|---|---|---|---|
| surface | K | 4-order | 6-order | 8-order | 10-order | 12-order | 14-order | 16-order |
| 3 | 9.30E+00 | −1.06E−02 | 1.15E−02 | −9.31E−03 | 4.62E−03 | −1.34E−03 | 1.91E−04 | −6.55E−06 |
| 4 | 3.87E−01 | −7.22E−04 | 4.17E−04 | −1.16E−04 | 1.78E−05 | −1.58E−06 | 7.56E−08 | −1.52E−09 |

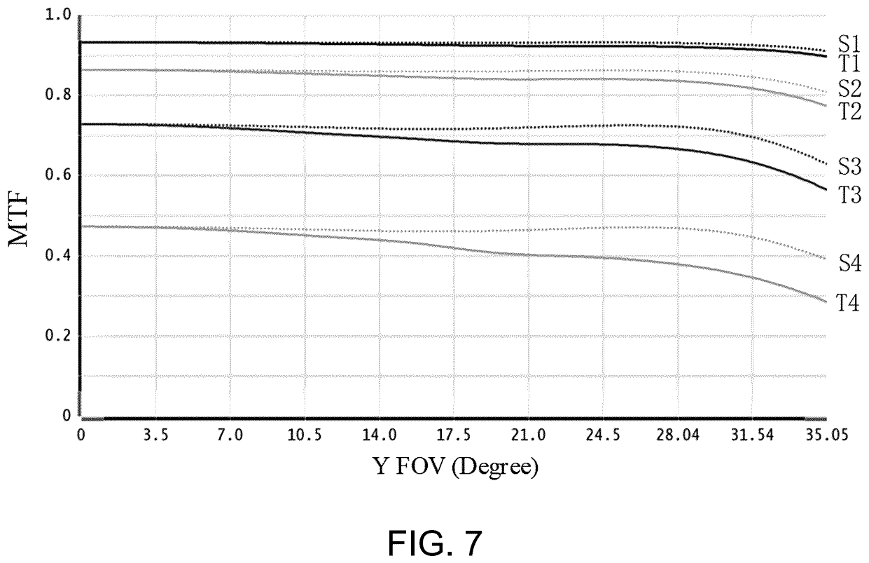

FIG. 7 shows an MTF diagram of the infrared optical system provided by Embodiment 3. The MTF (modulation transfer function) is an important indicator used to describe the imaging quality of an infrared optical system. The larger the value of MTF is, the better the imaging quality. As shown in FIG. 7, the meridional curve T1 and the sagittal curve S1 correspond to the spatial frequency of 5.25 lp/mm (line pair/mm), and the meridional curve T2 and the sagittal curve S2 correspond to the spatial frequency of 10.51 lp/mm, and the meridional curve T3 and the sagittal curve S3 correspond to the spatial frequency of 21 lp/mm, and the meridional curve T4 and the sagittal curve S4 correspond to the spatial frequency of 42 lp/mm. It can be seen in the above eight curves, that although the infrared optical system 100 has an acceptable edge imaging quality, the MTF at the FOV of 35.05° is always greater than 0.3. Therefore, the infrared optical system 100 has better central imaging quality. The Y FOV in FIG. 7 represents the field of view in the direction of the Y axis.

### Embodiment 4

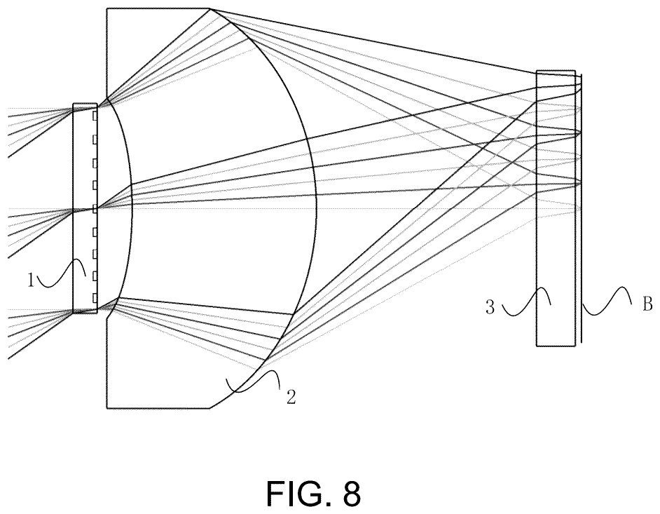

FIG. 8 shows an optical architecture diagram of the infrared optical system 100 provided by embodiment 4 of the present application. FIG. 8 shows the outputting optical performance of the infrared optical system 100 in embodiment 4. As shown in FIG. 8 and FIG. 1, an infrared optical system 100 in the present application, the infrared optical system 100 along the optical axis S includes a metalens 1, an aspheric lens 2, and an optical protective element 3 in order from an object side to an image side.

TABLE 10
Various system parameters of the infrared
optical system 100 provided by Embodiment 4

| System parameters | Data | |
|---|---|---|
| TTL (total track length) | 7.82 | mm |
| Field of view(2ω) | 70.2° | |
| F number | 1 | |
| Effective focal length | 3.126 | mm |
| Working waveband | 8~12 | μm |

As shown in Table 10, the infrared optical system 100 provided by the present application works at a target waveband of 8˜12 μm, which can satisfy the requirement of working at a far-infrared waveband. The F number (aperture size) of the infrared optical system 100 is 1, which can improve the light intake of the infrared optical system 100 significantly. And when the imaging sensor has a lower response to light, the infrared optical system 100 can collect the optical energy into the infrared optical system 100, which will ensure good imaging quality. At the same time, the infrared optical system 100 has a larger FOV (field of view), and the FOV is 70.2°. At the same time, the total track length of the infrared optical system 100 is only 7.82 mm, which can fully satisfy the requirements of miniaturization and light, therefore it is beneficial to control the volume.

From an object side to an image side, each surface of the infrared optical system provided by the infrared optical system is numbered. After summarizing the parameters of each surface, Table 11 is shown below.

TABLE 11
Parameters of the various surfaces in the infrared
optical system 100 provided by Embodiment 4

| Numbered | | Curvature | | |
|---|---|---|---|---|
| surface | Type of surface | radius | Thickness | Material |
| 1 | Object plane | Infinite | — | — |
| 2 | Spherical surface | Infinite | 0.38 mm | Silicon |
| 3 | Structural surface | Infinite | 0.54 mm | — |
| 4 | Aspheric surface | −5.94 mm | 2.84 mm | IRG206 |
| 5 | Aspheric surface | −3.99 mm | 3.39 mm | — |
| 6 | Spherical surface | Infinite | 0.60 mm | Silicon |
| 7 | Spherical surface | Infinite | 0.09 mm | — |
| 8 | Image plane | Infinite | — | — |

In Table 11, the surface 1 is an object plane. The surface 2 is an object-side surface of the metalens 1. The surface 3 is an image-side surface of a metalens 1, and the nanostructures are set on the surface 3 in the present application, that is, the surface 3 is recorded as a structural surface. The surface 4 is the object-side surface of the aspheric lens 2. The surface 5 is an image-side surface of the aspheric surface 2. The surface 6 is an object-side surface of the optical protective element 3. The surface 7 is an image-side surface of the optical protective element 3. The surface 8 is an image plane.

It can be seen in Table 11 that the curvature radius of surface 1 is infinite. That is, the surface 1 is a plane, and the distance between the surface 1 and the surface 2 is uncertain. There is air filled between surface 1 and surface 2. Surface 2 is a spherical surface, and the distance between the surface 2 and the surface 3 is 0.38 mm. The material between surface 2 and surface 3 is silicon. The surface 3 is a structural surface 11, and the surface 3 is a plane. The distance between the surface 3 and surface 4 is 0.54 mm. There is air filled between surface 3 and surface 4. The curvature radius of surface 4 is −5.94 mm. The distance between surface 4 and surface 5 is 2.84 mm. The material between surface 4 and surface 5 is IRG206. The curvature radius of surface 5 is −3.99 mm, and the distance between surface 5 and surface 6 is 3.39 mm. There is air filled between surface 5 and surface 6. The surface 6 is a spherical surface, and the distance between surface 6 and surface 7 is 0.60 mm. The material between surface 6 and surface 7 is silicon. The surface 7 is aspheric surface, and the distance between surface 7 and surface 8 is 0.09 mm. There is air filled between surface 7 and surface 8. The surface 8 is a plane.

The surface 3 and surface 4 are even-order aspheric surfaces, the even-order aspheric surfaces can be determined by the above formula.

TABLE 12
Parameters of each even-order aspheric surface in the infrared optical system provided by Embodiment 4

| Numbered | | | | | | | | |
|---|---|---|---|---|---|---|---|---|
| surface | K | 4-order | 6-order | 8-order | 10-order | 12-order | 14-order | 16-order |
| 3 | 3.95E+00 | −1.53E−02 | 1.07E−02 | −6.67E−03 | 8.08E−04 | 7.09E−04 | −3.09E−04 | 3.27E−05 |
| 4 | −3.89E−01 | −3.34E−05 | −9.59E−04 | 3.19E−04 | −6.71E−05 | 7.29E−06 | −3.92E−07 | 6.94E−09 |

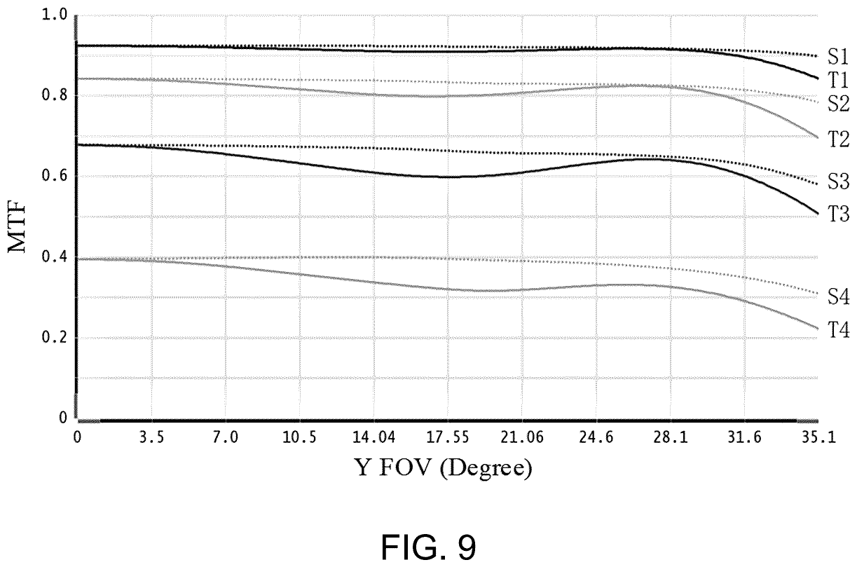

FIG. 9 shows an MTF diagram of the infrared optical system provided by Embodiment 4. The MTF (modulation transfer function) is an important indicator used to describe the imaging quality of an infrared optical system. The larger the value of MTF is, the better the imaging quality. As shown in FIG. 9, the meridional curve T1 and the sagittal curve S1 correspond to the spatial frequency of 5.25 lp/mm (line pair/mm), and the meridional curve T2 and the sagittal curve S2 correspond to the spatial frequency of 10.51 lp/mm, and the meridional curve T3 and the sagittal curve S3 correspond to the spatial frequency of 21 lp/mm, and the meridional curve T4 and the sagittal curve S4 correspond to the spatial frequency of 42 lp/mm. It can be seen in the above eight curves, that although the infrared optical system 100 has an acceptable edge imaging quality, the MTF at the FOV of 35.1° is always greater than 0.2. Therefore, the infrared optical system 100 has better central imaging quality. The Y FOV in FIG. 9 represents the field of view in the direction of the Y axis.

### Embodiment 5

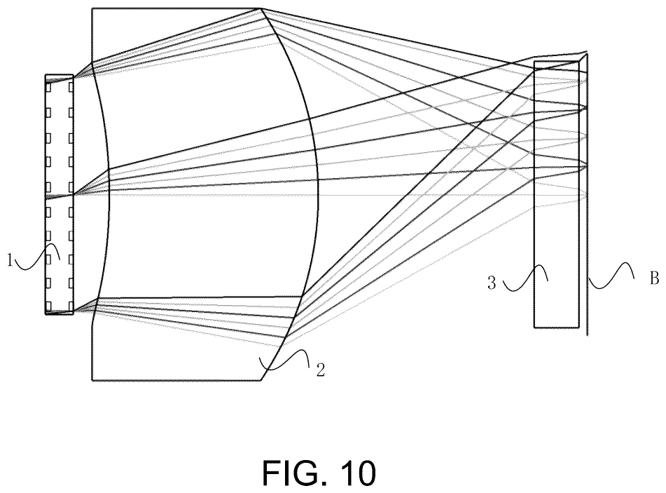

FIG. 10 shows an optical architecture diagram of the infrared optical system 100 provided by embodiment 4 of the present application. FIG. 10 shows the outputting optical performance of the infrared optical system 100 in embodiment 5. As shown in FIG. 10 and FIG. 1, in the embodiment 5, the infrared optical system 100 along the optical axis S includes a metalens 1, an aspheric lens 2, and an optical protective element 3 in order from an object side to an image side.

TABLE 13
Various system parameters of the infrared
optical system provided by Embodiment 4

| System parameters | Data | |
|---|---|---|
| TTL (total track length) | 7.28 | mm |
| Field of view(2ω) | 70.2° | |
| F number | 1 | |
| Effective focal length | 3.12 | mm |
| Working waveband | 8~12 | μm |

As shown in Table 10, the infrared optical system 100 provided by the present application works at a target waveband of 8˜12 μm, which can satisfy the requirement of working at a far-infrared waveband. The F number (aperture size) of the infrared optical system 100 is 1, which can improve the light intake of the infrared optical system 100 significantly. And when the imaging sensor has a lower response to light, the infrared optical system 100 can collect the optical energy into the infrared optical system 100, which will ensure good imaging quality. At the same time, the infrared optical system 100 has a larger FOV (field of view), and the FOV is 70.2°. At the same time, the total track length of the infrared optical system 100 is only 7.28 mm, which can fully satisfy the requirements of miniaturization and light, therefore it is beneficial to control the volume.

From an object side to an image side, each surface of the infrared optical system provided by the infrared optical system is numbered. After summarizing the parameters of each surface, Table 14 is shown below.

TABLE 14
Parameters of the various surfaces in the infrared
optical system provided by Embodiment 5

| Numbered | | Curvature | | |
|---|---|---|---|---|
| surface | Type of surface | radius | Thickness | Material |
| 1 | Object plane | Infinite | — | — |
| 2 | Spherical surface | Infinite | 0.38 mm | Silicon |
| 3 | Structural surface | Infinite | 0.49 mm | — |
| 4 | Aspheric surface | −7.14 mm | 2.81 mm | IRG206 |
| 5 | Aspheric surface | −4.35 mm | 2.90 mm | — |
| 6 | Spherical surface | Infinite | 0.60 mm | Silicon |
| 7 | Spherical surface | Infinite | 0.11 mm | — |
| 8 | Image plane | Infinite | — | — |

In Table 14, the surface 1 is an object plane. The surface 2 is an object-side surface of the metalens 1. The surface 3 is an image-side surface of a metalens 1, and the nanostructures are set on the surface 3 in the present application, that is, the surface 3 is recorded as a structural surface. The surface 4 is the object-side surface of the aspheric lens 2. The surface 5 is an image-side surface of the aspheric surface 2. The surface 6 is an object-side surface of the optical protective element 3. The surface 7 is an image-side surface of the optical protective element 3. The surface 8 is an image plane.

It can be seen in Table 14, the curvature radius of surface 1 is infinite. That is, the surface 1 is a plane, and the distance between the surface 1 and the surface 2 is uncertain. There is air filled between surface 1 and surface 2. Surface 2 is a spherical surface, and the distance between the surface 2 and the surface 3 is 0.38 mm. The material between surface 2 and surface 3 is silicon. The surface 3 is a structural surface 11, and the surface 3 is a plane. The distance between the surface 3 and surface 4 is 0.49 mm. There is air filled between surface 3 and surface 4. The curvature radius of surface 4 is −7.14 mm. The distance between surface 4 and surface 5 is 2.81 mm. The material between surface 4 and surface 5 is IRG206. The curvature radius of surface 5 is −4.35 mm, and the distance between surface 5 and surface 6 is 2.90 mm. There is air filled between surface 5 and surface 6. The surface 6 is a spherical surface, and the distance between surface 6 and surface 7 is 0.60 mm. The material between surface 6 and surface 7 is silicon. The surface 7 is an aspheric surface, and the distance between surface 7 and surface 8 is 0.11 mm. There is air filled between surface 7 and surface 8. The surface 8 is a plane.

The surface 3 and surface 4 are even-order aspheric surfaces, the even-order aspheric surfaces can be determined by the above formula.

TABLE 15
Parameters of each even-order aspheric surface in the infrared optical system provided by Embodiment 5

| Numbered | | | | | | | | |
|---|---|---|---|---|---|---|---|---|
| surface | K | 4-order | 6-order | 8-order | 10-order | 12-order | 14-order | 16-order |
| 3 | 2.17E+00 | −6.65E−03 | 8.01E−03 | −6.14E−03 | 1.07E−03 | 6.91E−04 | −3.07E−04 | 3.67E−05 |
| 4 | −9.85E−01 | 4.84E−04 | −1.15E−03 | 3.25E−04 | −5.79E−05 | 7.29E−06 | −7.38E−07 | 4.42E−08 |

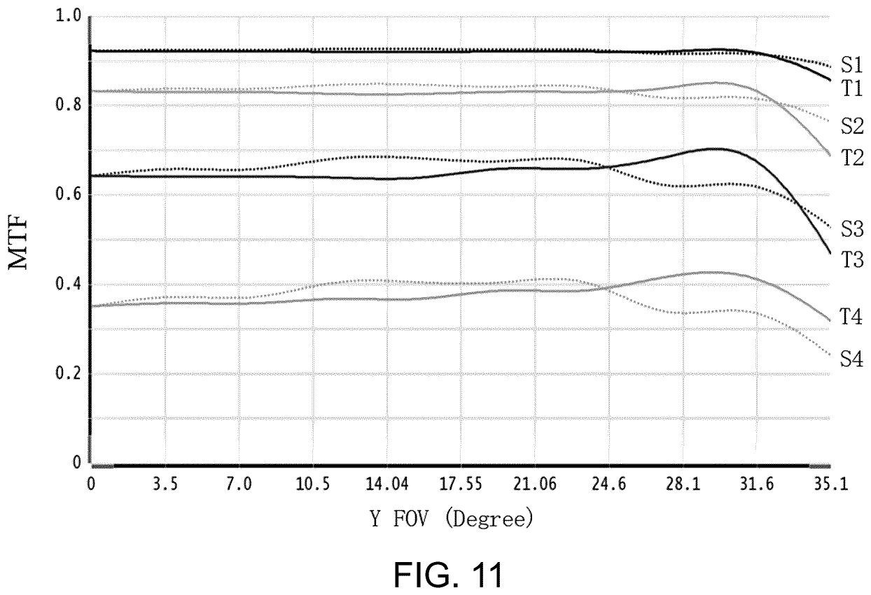

FIG. 11 shows an MTF diagram of the infrared optical system provided by Embodiment 4. The MTF (modulation transfer function) is an important indicator used to describe the imaging quality of an infrared optical system. The larger the value of MTF is, the better the imaging quality. As shown in FIG. 11, the meridional curve T1 and the sagittal curve S1 correspond to the spatial frequency of 5.25 lp/mm (line pair/mm), and the meridional curve T2 and the sagittal curve S2 correspond to the spatial frequency of 10.51 lp/mm, and the meridional curve T3 and the sagittal curve S3 correspond to the spatial frequency of 21 lp/mm, and the meridional curve T4 and the sagittal curve S4 correspond to the spatial frequency of 42 lp/mm. It can be seen in the above eight curves, that although the infrared optical system 100 has an acceptable edge imaging quality, the MTF at the FOV of 35.1° is always greater than 0.2. Therefore, the infrared optical system 100 has better central imaging quality. The Y FOV in FIG. 9 represents the field of view in the direction of the Y axis.

After summarizing the various parameters of each aspherical surface in the infrared optical system provided by the above five embodiments, Table 16 is shown below. The displays in Table 16 are mainly used to explain the conditions met by the optical system working the far-infrared waveband provided by this application, and are experimentally verified and supported.

TABLE 16
The various parameters of the infrared optical system 100 provided by the
above embodiments

| | Embodiment | | Embodiment | | Embodiment | | Embodiment | | Embodiment | |
|---|---|---|---|---|---|---|---|---|---|---|
| Condition | 1 | | 2 | | 3 | | 4 | | 5 | |
| fₘ | 8.19 | mm | 9.17 | mm | 9.65 | mm | 10.77 | mm | 7.404 | mm |
| f | 3.11 | mm | 3.4 | mm | 3.18 | mm | 3.126 | mm | 3.12 | mm |
| $\frac{{f}_{m}}{f}$ | 2.63 | | 2.70 | | 3.04 | | 3.44 | | 2.38 | |
| Φₘₐₓ | 122.1 | D | 109.1 | D | 103.6 | D | 92.9 | D | 135.1 | D |
| Φₘᵢₙ | 111.7 | D | 103.6 | D | 101.5 | D | 84.5 | D | 128.2 | D |
| ΔΦₘ | 10.4 | D | 5.5 | D | 2.1 | D | 8.4 | D | 6.9 | D |
| L₁ | 2.83 | mm | 2.75 | mm | 4.31 | mm | 3.75 | mm | 3.67 | mm |
| L | 6.38 | mm | 7.36 | mm | 8.7 | mm | 7.82 | mm | 7.28 | mm |
| $\frac{{L}_{1}}{L}$ | 0.44 | | 0.37 | | 0.49 | | 0.48 | | 0.50 | |
| MTFₐᵥₑ | 0.3 | | 0.3 | | 0.44 | | 0.335 | | 0.33 | |
| $\frac{{MTF}_{ave}}{L}$ | 0.047 | mm−1 | 0.041 | mm−1 | 0.051 | mm−1 | 0.043 | mm−1 | 0.045 | mm−1 |
| Φₘ | 122.07 | D | 109.1 | D | 103.6 | D | 92.9 | D | 135.1 | D |
| Φₐ | 264.13 | D | 240.9 | D | 278.9 | D | 283.4 | D | 263.0 | D |
| Tₘ | 0.375 | mm | 0.375 | mm | 0.375 | mm | 0.375 | mm | 0.375 | mm |
| Tₐ | 1.53 | mm | 1.21 | mm | 3.40 | mm | 2.84 | mm | 2.81 | mm |
| $\frac{{Φ}_{m}}{{T}_{m}} - \frac{{Φ}_{a}}{{T}_{a}}$ | 152.9 | D/mm | 91.8 | D/mm | 194.2 | D/mm | 147.9 | D/mm | 266.7 | D/mm |
| ϕₘₐₓ | 7.66 | p | 6.23 | p | 11.80 | p | 6.30 | p | 7.07 | p |
| rₘ | 1.4 | mm | 1.53 | mm | 1.6 | mm | 1.55 | mm | 1.57 | mm |
| $\frac{{ϕ}_{max}}{{r}_{m}}$ | 5.47 | p/mm | 4.07 | p/mm | 7.38 | p/mm | 4.06 | p/mm | 4.50 | p/mm |
| ∇Φₘₐₓ | 10 | rad/mm | 3.7 | rad/mm | 1.1 | rad/mm | 9.3 | rad/mm | 5.9 | rad/mm |
| ∇Φₘᵢₙ | −18.1 | rad/mm | −9 | rad/mm | −4 | rad/mm | −21.8 | rad/mm | −15.4 | rad/mm |
| ∇Φₘₐₓ − | 28.1 | rad/mm | 12.7 | rad/mm | 5.1 | rad/mm | 31.1 | rad/mm | 21.3 | rad/mm |
| ∇Φₘᵢₙ | | | | | | | | | | |
| Δgdₘ | 85 | fs | 71 | fs | 108 | fs | 94 | fs | 90 | fs |
| Δgdₜ | −63 | fs | −58 | fs | −116 | fs | −80 | fs | −82 | fs |

| | | | | | |
|---|---|---|---|---|---|
| $\frac{\vert Δ {gd}_{m} \vert}{\vert Δ {gd}_{t} \vert}$ | 1.35 | 1.22 | 0.93 | 1.17 | 1.1 |
| n_{eff} | 2 | 2.7 | 1.1 | 1.8 | 2.5 |
| nₜ | 2.78 | 2.78 | 3.13 | 2.78 | 2.78 |
| $\frac{{n}_{eff}}{{n}_{t}}$ | 0.72 | 0.97 | 0.35 | 0.65 | 0.90 |

An infrared optical camera 1000 is provided, and the infrared optical camera 1000 includes a lens barrel 200 and the infrared optical system 100. The architecture of the infrared optical system 100 is as described above and will not be repeated here. The lens barrel 200 is used to provide the installation base for the infrared optical system 100, and the infrared optical system 100 is set inside the lens barrel 200.

This application provides three embodiments of different structures of the infrared optical lens 1000 and next, there is a detailed introduction of the infrared optical lens 1000 provided by various embodiments of this application. None of the following three embodiments is provided with the optical protective element 3. The optical protective element 3 may be provided by side the infrared optical camera 1000, and the optical protective element 3 may also be provided outside the electronic device (not shown in figures) including the image sensor and the infrared optical camera 1000. The imaging sensor includes but is not limited to CMOS (Complementary Metal Oxide Semiconductor) and CCD (Charge Coupled Device).

### Embodiment 1

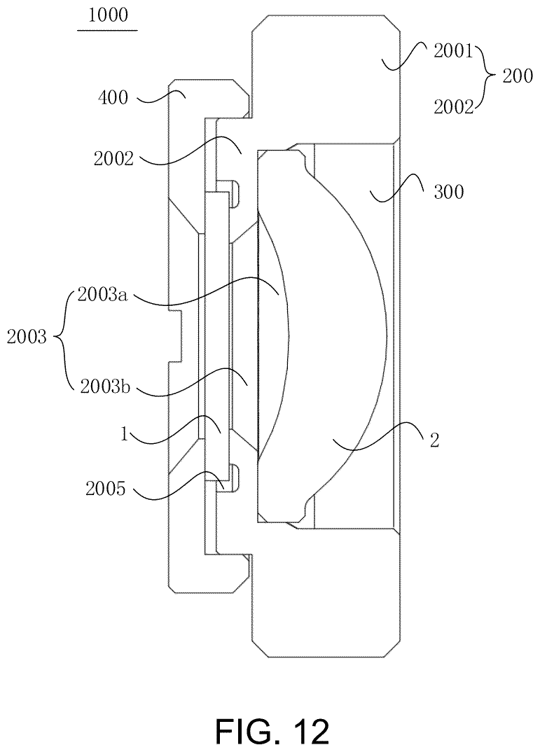

As shown in FIG. 12 and FIG. 1, the infrared optical camera 1000 includes a main body portion 2001 and a bearing portion 2002. A first installation hole 2003 is set inside the lens barrel 200, and the first installation hole 2003 is used to mount at least partial infrared optical system 100. Both the lens barrel 200 and the main body portion 2001 are about cylindrical. The axial direction of the main body portion 2001 may be parallel to the optical axis S, or the axial direction of the main body portion 2001 may overlap with the optical axis S.

The bearing portion 2002 is about cylindrical, and the bearing portion 2002 is connected to one side of the main body portion 2001 along the optical axis S, that is, the bearing portion 2002 is connected to the axial side of the main body portion 2001. The diameter of the bearing portion 2002 is not equal to the diameter of the main body portion 2001, which makes the axial profile lens barrel 200 in the form of steps. In one embodiment, the diameter of the bearing portion 2002 is less than the diameter of the main body portion 2001, which makes the axial profile lens barrel 200 in the form of steps. In one embodiment, the diameter of the bearing portion 2002 is greater than the diameter of the main body portion 2001, which makes the axial profile lens barrel 200 in the form of steps. And a mounting hole is set on one side of the bearing portion far away from the main body portion 2001, and the mounting hole 2005 is coaxial with the first installation hole 2003.

The first installation hole 2003 includes a first hole section 2003a and the second hole section 2003b. The first hole section 2003a is set on the main body portion 2001. The second hole section 2003b is set on the bearing portion. The second hole section 2003b is connected to the first hole section 2003a and the second hole section 2003b is coaxial with the first hole section 2003a. The diameter of the second hole section 2003b is less than the diameter of the first hole section 2003a, so that the first installation hole 2003 is a stepped hole, and the transition between the first hole section 2003a and the second hole section 2003b is the mutation of the caliber of the installation hole 2003.

The aspheric lens 2 is set inside the first hole section 2003a, and the aspheric lens 2 is connected to the main body portion 2001 to fix the aspheric lens 2. The aspheric lens 2 contacts the bearing portion 2002, because the transition between the first hole section 2003a and the second hole section 2003b is in the form of steps, therefore, the aspheric lens 2 contacts the bearing portion 2002, the aspheric lens 2 may be limited along one side of the optical axis to reduce the loose probability of the aspheric lens 2.

For the connection mode of the aspheric lens 2 and the main body portion 2001, the connection mode of the aspheric lens 2 and the main body portion 2001 includes but is not limited to the thread connection or bonding.

Specifically: (1) When the aspheric lens 2 is connected to the main body portion 2001, the inner wall of the first hole section 2003a of the body 2001 is provided with a first inner thread (which is not shown in figures). And the outer wall of the aspheric lens 2 is set with the first outer thread that matches with the first inner thread (which is not shown in figures). When the installation, firstly the aspheric lens 2 is set in a pre-set position in the first hole section 2003a, and then the aspheric lens 2 is connected to the main body portion 2001, and the aspheric lens 2 contacts the bearing portion 2002.

(2) When the aspheric lens 2 is bonded to the main body portion 2001, the adhesive is coated on the outer edge of the aspheric lens 2, then the aspheric lens 2 is placed in a preset position within the first hole section 2003a so that the aspheric lens 2 is bonded with the main body portion 2001 by the adhesive, and the aspheric lens 2 is bonded to the bearing portion 2002. Optionally, the adhesive is coated at the pre-set position of the inner wall of the first hole section 2003a, and the aspheric lens 2 is set inside the first hole section 2003a, so that the aspheric lens 2 is connected to the main body portion 2001. The aspheric lens 2 is connected to the bearing portion 2002.

For the diameter of the first hole section 2003a, the diameter of one end that is closer to the bearing portion 2002 of the first hole section 2003a is less than the diameter of the end that is away from the bearing portion 2002 of the first hole section 2003a, thus facilitating the aspheric lens 2 getting into the pre-set position within the first hole section 2003a.

Referring to FIG. 12, the infrared optical camera 1000 also includes a first-pressing ring 300. The first-pressing ring is about annual. The first-pressing ring 300 is set inside the first hole section 2003a, and the first-pressing ring 300 is pressed to the aspheric lens 2 to limit the location of the aspheric lens 2 along the optical axis. The first-pressing ring 300 and the bearing portion 2002 may completely fix the aspheric lens 2, which can avoid the aspheric lens 2 from getting loose.

For the connection mode of the first-pressing ring 300 and the main body portion 2001, the connection mode of the first-pressing ring 300 and the main body portion 2001 includes but is not limited to thread connection and bonding.

Specifically: (1) When the first-pressing ring 300 is connected to the inner thread of the main body portion 2001, the inner wall of one end that is away from the bearing portion 2002 of the first hole section 2003a is provided with a second inner thread (which is not shown in figures). When the installation, the first-pressing ring 300 is rotated into a pre-set position of the first hole section 2003a, so that the first-pressing ring 300 is connected to the main body portion 2001 by threads, and the first-pressing ring 300 is pressed to the aspheric lens 2.

(2) When the first-pressing ring 300 is bonded to the main body portion 2001 by the adhesive, the adhesive is coated on the outer edge of the first-pressing ring 300. Then the first-pressing ring 300 is set inside a pre-set position within the first hole section 2003a, so that the first-pressing ring 300 is bonded with the main body portion 2001 by the adhesive, and the first-pressing ring 300 is pressed to the aspheric lens 2. Optionally, the adhesive is coated on the pre-set position of the inner wall of the first hole section 2003a, and then the first pressure ring 300 is rotated into the first hole section 2003a, so that the first pressure ring 300 is bonded with the main body portion 2001. And the first pressure ring 300 is pressed to the aspheric lens 2.

One side away from the aspheric lens 2 of the first-pressing ring 300 is not protruding from the main body portion 2001. Specifically, one side of the first pressure ring 300 away from the aspheric lens 2 is aligned with the side of the main body portion 2001 away from the bearing portion 2002. Optionally, one side of the first-pressing ring 300 away from the aspheric lens 2 is located on the inner side of the main body portion 2001 away from the bearing portion 2002. The side of the first pressure ring 300 away from the aspheric lens 2 is not protruding from the main body portion 2001, thus avoiding the length of the infrared optical camera 1000 increasing.

In one embodiment, the metalens 1 is mounted in the mounting hole 2005, and the metalens 1 is connected to the bearing portion 2002 to fix the metalens 1.

For the connection mode of the metalens 1 and the bearing portion 2002, the connection mode of the metalens 1 and the bearing portion 2002 includes but is not limited to thread connection and bonding.

Specifically: (1) When the metalens 1 and the bearing portion 2002 are connected by the thread, the inner wall of the mounting hole 2005 is set with a third inner thread (which is not shown in the figures). And the outer edge of the metalens 1 is set with a third outer thread (which is not shown in the figures). When the installation, the metalens 1 is set into a pre-set position of the mounting hole 2005, so that the metalens 1 is connected to the bearing portion 2002 by threads.

(2) When the metalens 1 is bonded to the bearing portion 2002, the adhesive is coated on the outer edge of the metalens 1. Then the metalens 1 is set inside a pre-set position of the mounting hole 2005, so that the metalens 1 is bonded with the bearing portion 2002 by the adhesive. Optionally, the adhesive is coated at the pre-set position of the inner wall of the mounting hole 2005, and then the metalens 1 is set inside the mounting hole 2005, so that the metalens 1 is bonded with the bearing portion 2002.

As shown in FIG. 12, the infrared optical camera 1000 further includes the second-pressing ring 400. The second pressure ring 400 is about annular. The second pressure ring 400 is connected to the bearing portion 2002, and the second pressure ring 400 is pressed to the metalens 1 to fix the metalens 1 along the optical axis S, which avoids the metalens 1 getting loose.

For the connection mode of the second-pressing ring 400 and the bearing portion 2002, the connection mode of the second-pressing ring 400 and the bearing portion 2002 includes but is not limited to thread connection and bonding.

Specifically: (1) When the second-pressing ring 400 is connected to the bearing portion 2001 by the thread, the outer edge of the bearing portion 2002 is provided with a fourth inner thread (which is not shown in the figures). When the installation, the second-pressing ring 400 is covered on the bearing portion 2002, then the second-pressing ring 400 is rotated into a pre-set position of the bearing section 2002, so that the second-pressing ring 400 is connected to the bearing portion 2002 by the threads, and the second-pressing ring 400 is pressed to the metalens 1.

(2) When the second-pressing ring 400 is bonded to the bearing portion 2002 by the adhesive, the adhesive is coated on the outer edge of the second-pressing ring 400. Then the first-pressing ring 300 is covered on the bearing portion 2002, so that the second-pressing ring 400 is bonded with the bearing portion 2002 by the adhesive, and the second-pressing ring 400 is pressed to the metalens 1. Optionally, the adhesive is coated on the outer edge of the bearing portion 2002, and then the first pressure ring 300 is covered on the bearing portion 2002, so that the second pressure ring 400 is bonded with the bearing portion 2002. And the second pressure ring 400 is pressed to the metalens 1.

The infrared optical camera 1000 also includes a sealing element (which is not shown in figures), and the sealing elements are set on the connection between the metalens 1 and the lens barrel 200, on the connection between the aspheric lens 2 and the lens barrel 200, and the connection between the first-pressing ring 300 and the lens barrel 200, and the connection between the second-pressing ring 400 and the lens barrel 200 to improve the sealing performance of the infrared optical camera 1000. In this way, the probability of the infrared optical camera 1000 has reduced. The sealing elements include but are not limited to the sealing rings, sealing tape and sealant.

The infrared optical camera 1000 installation method is: according to FIG. 12, the aspheric lens 2 is set on a pre-set location, the aspheric lens 2 is connected to the main body portion 2001, then the first-pressing ring 300 is installed. And the first-pressing ring 300 is connected to the main body portion 2001, and the first-pressing ring 300 is pressed to the aspheric lens 2. The metalens 1 is then mounted on the mounting hole 2005, so that the metalens 1 is connected to the bearing portion 2002. And the second pressure ring 400 is connected to the bearing portion 2002 finally, and the second pressure ring 400 is pressed to the metalens 1. And the installation sequence of the aspheric lens 2 and metalens 1 can be switched, that is, the metalens 1 is installed, and then the aspheric lens 2 is installed.

### Embodiment 2

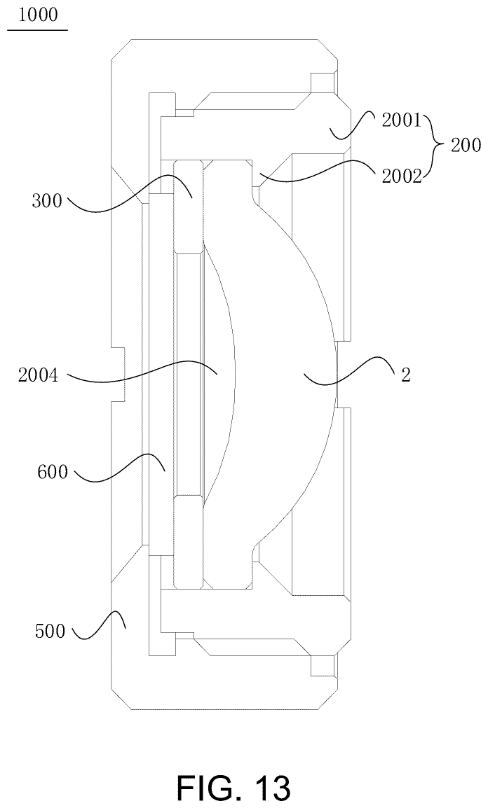

Referring to FIG. 13 and FIG. 1, the lens barrel 200 is provided with a second installation hole 2004, and the second installation hole 2004 is used to mount at least part of the infrared optical system 100. And the axial direction of the second installation hole 2004 may be parallel to the optical axis S, or the axial direction of the second installation hole 2004 may overlap with the optical axis S. The lens barrel 200 includes the main body portion 2001 and the bearing portion 2002. The main body portion 2001 is the portion of the main body of the lens barrel 200, and the main body portion 2001 is about cylindrical. The axial direction of the main body portion 2001 may be parallel to the optical axis S, or the axial direction of the main body portion 2001 may overlap with the optical axis S, and the second installation hole 2004 is located at the main body portion 2001.

The second installation hole 2004 is set in the main body portion 2002, and the bearing portion 2002 is connected to the inner wall of the second installation hole 2004. The bearing portion 2002 is used to support the aspheric lens 2 along the axial direction of the second installation hole 2005. Optionally, the bearing portion may be a ring. The bearing portion 2002 may be composed of at least two bumps, and there is a gap between the two bumps. The radial profile of each bump along the lens barrel 200 should be in the same plane.

The aspheric lens 2 is set inside the second installation hole 2004. And the aspheric lens 2 is connected to the main body portion 2002. The aspheric lens 2 contacts the bearing portion 2002 to limit the location of the aspheric lens 2 along one side of the second installation hole 2004 in the radial direction. The installation method of the aspheric lens 2 can refer to the embodiment above, which will not be described here.

The metalens 1 is set inside the second installation hole 2004, and the metalens 1 is located at one side of the aspheric lens 2 along the axis direction of the second installation hole 2004. And the metalens 1 is connected to the main body portion 2001 to fix the metalens 1. And the metalens 1 contacts the aspheric lens 2 to limit the location of the metalens 1 along one side of the second installation hole 2004 in the radial direction, which will reduce the loose probability of the metalens 1. The installation method of the metalens 1 can refer to the embodiment above, which will not be described here.

Referring to FIG. 13, the infrared optical camera further includes a buffer element 600 and a third-pressing ring 500. The buffer element 600 is about annual. And the buffer element 600 is sandwiched between the metalens 1 and the aspheric lens 2, so that the metalens 1 contacts the aspheric lens 2. The buffer element 600 may be a gasket. The third-pressing ring 500 is about annual, and the third-pressing ring 500 is covered on the metalens 1 and contacts the main body portion 2001 to limit the metalens 1 and the aspheric lens 2 completely, and the loose probability of the aspheric lens 2 and the metalens 1 can be reduced. When the third-pressing ring 500 is connected to the main body portion 2001, the third-pressing ring 500 is covered on the main body portion 2001. The fixing mode of the third-pressing ring 500 includes but is not limited to thread connection and bonding, and the specific installation mode of the third-pressing ring 500 may refer to the fixing mode of the first-pressing ring 300 or the second-pressing ring 400 mentioned above.

In the present embodiment, the installation method of the infrared optical camera 1000 is: according to FIG. 13, the aspheric lens 2 in the second installation hole 2004 is connected to the aspheric lens 2 to the main body portion 2001, and the aspheric lens 2 is connected to the bearing portion 2002. The buffer element 600 is set inside the second installation hole 2004, and then the metalens 1 is set in a pre-set position of the second installation hole 2004. And the metalens 1 is bonded to the main body portion 2001. Finally, the third-pressing ring 500 is covered on the main body portion 2001, and the third-pressing ring 500 is connected to the main body portion 2001.

### Embodiment 3

The lens barrel 200 is set with a third installation hole (which is not shown in the figures), and the third installation hole is used to mount the infrared optical system 100. The axial direction of the main body portion 2001 is parallel to the optical axis S, or overlaps with the optical axis S, and the third installation hole is located at the main body portion 2001. Both the metalens 1 and the aspheric lens 2 are bonded to the inner wall of the third installation hole to fix the metalens 1 and the aspheric lens 2.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An infrared optical system, comprising a metalens and an aspheric lens in order from an object side to an image side along an optical axis;
wherein, each of the metalens and the aspheric lens comprises an object-side surface facing towards the object side and an image-side surface facing towards the image side;
the object-side surface of the aspheric lens is convex to the image side, and the image-side surface of the aspheric lens is convex to the image side;
the metalens satisfies a condition as follows:
0.8<n_{eff}<3.6;
wherein n_{eff} is an effective refractive index;
the infrared optical system satisfies a condition as follows:
$$0.36 < \frac{{L}_{1}}{L} < 0.51 ;$$
wherein L₁ is a distance between the object-side surface of the metalens and object-side surface of the aspheric lens; and L is a total track length of the infrared optical system.

2. The infrared optical system according to claim 1, wherein the infrared optical system satisfies a condition as follows:
2.1D≤ΔΦₘ≤10.4D
wherein ΔΦₘ is a difference between a maximum focal power of the metalens and a minimum focal power of the metalens at a working waveband.

3. The infrared optical system according to claim 1, wherein the infrared optical system satisfies a condition as follows:
$$2.38 < \frac{{f}_{m}}{f} < 3.44$$
wherein fₘ is a focal length of the metalens, and f is an effective focal length of the infrared optical system.

4. The infrared optical system according to claim 1, wherein the infrared optical system satisfies a condition as follows:
$$91.8 D / mm < \frac{{Φ}_{m}}{{T}_{m}} - \frac{{Φ}_{a}}{{T}_{a}} < 266.7 D / mm$$
wherein Tₘ is a thickness of the metalens; Tₐ is a central thickness of the aspheric lens along the optical axis; Φₐ is a focal power of the aspheric lens; and Φₘ is a focal power of the metalens.

5. The infrared optical system according to claim 1, wherein the infrared optical system satisfies a condition as follows:
$$4.06 p / mm < \frac{{ϕ}_{max}}{{r}_{m}}$$
wherein Φₘₐₓ is a maximum phase of the metalens, and rₘ is a radius of an effective region of the metalens.

6. The infrared optical system according to claim 1, wherein the infrared optical system satisfies a condition as follows:
$$0.32 < \frac{{n}_{eff}}{{n}_{t}} < 0.98$$
wherein n_{eff} is an effective refractive index of the metalens; and nₜ is a refractive index of the aspheric lens.

7. The infrared optical system according to claim 1, wherein the infrared optical system satisfies a condition as follows:
$$5. rad / mm < ∇ {Φ}_{max} - ∇ {Φ}_{min} < 31.2 rad / mm$$
wherein ∇Φₘₐₓ is a maximum spatial phase gradient of the metalens; and ∇Φₘᵢₙ is a minimum spatial phase gradient of the metalens.

8. The infrared optical system according to claim 1, wherein the infrared optical system satisfies a condition as follows:
$$0.93 < \frac{\vert Δ {gd}_{m} \vert}{\vert Δ {gd}_{t} \vert} < 1.35$$
wherein Δgdₘ is a maximum group delay of nanostructures of the metalens; and Δgdₜ is a maximum group delay of the aspheric lens.

9. The infrared optical system according to claim 1, wherein the infrared optical system satisfies a condition as follows:
1<n_{eff}<3.5.
wherein n_{eff} is an effective refractive index of the metalens.

10. The infrared optical system according to claim 1, wherein the infrared optical system satisfies a condition as follows:
$$0.04 {mm}^{- 1} < \frac{{MTF}_{ave}}{L} < 0.052 {mm}^{- 1}$$
wherein MTFₐᵥₑ is an average of a value of modulation transfer function at a cut-off frequency of full filed of view; and L is a total track length of the infrared optical system.

11. The infrared optical system according to claim 1, wherein a central thickness of the aspheric lens is greater than 1.21 mm, and is less than 3.40 mm.

12. The infrared optical system according to claim 1, wherein a total track length of the infrared optical system is greater than or equal to 6.38 mm, and is less than or equal to 8.7 mm.

13. The infrared optical system according to claim 1, wherein a focal length of the metalens is greater than or equal to 7.404 mm, and is less than or equal to 10.77 mm.

14. The infrared optical system according to claim 1, wherein a back focal length of the infrared optical system is greater than or equal to 3.61 mm, and is less than or equal to 4.08 mm.

15. The infrared optical system according to claim 1, wherein an effective focal length of the infrared optical system is greater than or equal to 3.11 mm, and is less than or equal to 3.4 mm.

16. An infrared optical camera, wherein the infrared optical camera comprises a lens barrel and the infrared optical system claimed as claim 1;
the infrared optical system is set inside the lens barrel.

17. The infrared optical camera according to claim 16, wherein the infrared optical camera comprises a main body portion and a bearing portion;
a first installations hole is set inside the lens barrel;
the bearing portion is connected to one side of the main body portion along the optical axis, and a mounting hole is set on one side of the bearing portion far away from the main body portion;
the first installation hole comprises a first hole section and a second hole section; the first hole section is set on the main body portion; the second hole section is set on the bearing portion;
a diameter of the second hole section is less than a diameter of the first hole section;
the aspheric lens is set inside the bearing portion, and the metalens is set inside the mounting hole, and the metalens is connected to the bearing portion.

18. The infrared optical camera according to claim 17, wherein the infrared optical camera further comprises a first-pressing ring and a second-pressing ring;
the first-pressing ring is pressed on the aspheric lens, and the first-pressing ring is connected to the main body portion; the second-pressing ring is pressed on the metalens, and the second-pressing ring is connected to the bearing portion.

19. The infrared optical camera according to claim 16, wherein the infrared optical camera further comprises a main body portion and a bearing portion; a second installation hole is set in the main body portion, and the aspheric lens is connected to the main body portion; the aspheric lens contacts the bearing portion; the metalens is located at one side of the aspheric lens along an axis direction of the second installation hole, and the metalens is connected to the main body portion.

20. The infrared optical camera according to claim 19, wherein the infrared optical camera further comprises a buffer element and a third-pressing ring;
the buffer element is set between the metalens and the aspheric lens;
the third-pressing ring is pressed on the metalens, and the third-pressing ring is connected to the main body.
